(19) United States
(12) Patent Application Publication
(10) Pub. No.: US 2025/0008463 A1
(43) Pub. Date: Jan. 2, 2025

(54) COMMUNICATION METHOD OF TERMINAL, TERMINAL, COMMUNICATION METHOD OF SATELLITE, AND SATELLITE IN NON-TERRESTRIAL NETWORK SYSTEM

(71) Applicant: Samsung Electronics Co., Ltd., Gyeonggi-do (KR)

(72) Inventors: Sunhyun KIM, Gyeonggi-do (KR); Daeun KO, Gyeonggi-do (KR); Dongmyung KIM, Gyeonggi-do (KR); Sangho LEE, Gyeonggi-do (KR)

(21) Appl. No.: 18/738,728

(22) Filed: Jun. 10, 2024

(30) Foreign Application Priority Data
Jun. 28, 2023 (KR) 10-2023-0083773

(51) Int. Cl. H04W 56/00; H04B 7/185

(52) U.S. Cl. CPC H04W 56/0045; H04B 7/18513

(57) ABSTRACT

Provided is a 5G or 6G communication system for supporting higher data rates than a 4G communication system. A method of a terminal in an NTN includes receiving a first broadcast message comprising at least part of synchronization information from a satellite at a first time point, receiving a second broadcast message comprising a remainder of the synchronization information from the satellite at a second time point, receiving a third broadcast message comprising location information related to a location of the satellite from the satellite at a third time point, determining a first location of the satellite at the first time point, a second location of the satellite at the second time point, and a third location of the satellite at the third time point, based on the first broadcast message, the second broadcast message, and the third broadcast message, determining a TA value related to a distance between the terminal and the satellite, based on the first location, the second location, and the third location, adjusting a transmission time point of an initial message for initial access to the satellite, based on the determined TA value, and transmitting the initial message to the satellite at the adjusted transmission time point.

### CROSS-REFERENCE TO RELATED APPLICATION

This application is based on and claims priority under 35 U.S.C. § 119 to Korean Patent Application No. 10-2023-0083773, filed on Jun. 28, 2023, in the Korean Intellectual Property Office, the disclosure of which is incorporated herein by reference in its entirety.

### BACKGROUND

### 1. Field

The disclosure relates generally to a wireless communication system, and more particularly, to a communication method of a terminal, the terminal, a communication method of a satellite, and the satellite in a non-terrestrial network (NTN) system.

### 2. Description of the Related Art

Based on the development of wireless communication, technologies have been developed mainly for services targeting humans, such as voice calls, multimedia services, and data services. Pursuant to the commercialization of fifth generation (5G) communication systems, it is expected that the number of connected devices will exponentially increase. Examples of connected things may include vehicles, robots, drones, home appliances, displays, smart sensors connected to various infrastructures, construction machines, and factory equipment. Mobile devices are expected to evolve in various form-factors, such as augmented reality (AR) glasses, virtual reality (VR) headsets, and hologram devices. To provide various services by connecting hundreds of billions of devices and things in the sixth generation (6G) era, there have been ongoing efforts to develop improved 6G communication systems. For these reasons, 6G communication systems are referred to as beyond 5G systems.

6G communication systems, which are expected to be commercialized around 2030, will have a peak data rate of terahertz (THz) (1,000 gigahertz (GHz level bps and a radio latency less than 100 μsec, and thus will be 50 times as fast as 5G communication systems and have a 1/10 radio latency.

To realize such a high data rate and an ultra-low latency, it has been considered to implement 6G communication systems in about 95 GHz to 3THz bands. It is expected that, due to severer path loss and atmospheric absorption in the THz bands than those in millimeter wave (mmWave) bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of THz-band signals, such as metamaterial-based lenses and antennas, orbital angular momentum (OAM), and reconfigurable intelligent surface (RIS).

Moreover, to improve the spectral efficiency and the overall network performances, technologies have been developed for 6G communication systems, including but not limited to a full-duplex technology for enabling an uplink (UL) transmission and a downlink (DL) transmission to simultaneously use the same frequency resource, a network technology for utilizing satellites, high-altitude platform stations (HAPS), and the like in an integrated manner, an improved network structure for supporting mobile base stations and enabling network operation optimization and automation, a dynamic spectrum sharing technology via collision avoidance based on a prediction of spectrum usage, use of artificial intelligence (AI) in wireless communication for improvement of overall network operation by utilizing AI from a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds, and the like) over the network. Through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will enable the next hyper-connected experience. Particularly, it is expected that services such as truly immersive extended reality (XR), high-fidelity mobile hologram, and digital replica could be provided through 6G communication systems. Services such as remote surgery for security and reliability enhancement, industrial automation, and emergency response will be provided through the 6G communication system such that the technologies could be applied in various fields such as industry, medical care, automobiles, and home appliances.

An NTN system uses a satellite as a relay device to establish a communication area in a region where it is physically or economically impossible to install a base station for mobile communication. An NTN system has technical difficulties in achieving frequency synchronization because a Doppler effect is continuously experienced even in a non-mobile terminal or satellite antenna, and in achieving time synchronization because a distance between a satellite and a terminal continuously changes. Conventionally, synchronization and initial access with a satellite have been performed with the help of a global navigation satellite system (GNSS). Accordingly, when the measurement accuracy and performance of a GNSS deteriorate, communication synchronization accuracy and communication performance deteriorate, and power consumption increases because the GNSS is continuously used.

Therefore, there is a need in the art for a method and apparatus to cure these deficiencies in the synchronization and access with a satellite in the GNSS system.

### SUMMARY

The disclosure has been made to address at least the above-mentioned problems and/or disadvantages and to provide at least the advantages described below.

In accordance with an aspect of the disclosure, a communication method of a terminal in an NTN includes receiving a first broadcast message comprising at least part of synchronization information from a satellite at a first time point, receiving a second broadcast message comprising a remainder of the synchronization information from the satellite at a second time point, receiving a third broadcast message comprising location information related to a location of the satellite from the satellite at a third time point, determining a first location of the satellite at the first time point, a second location of the satellite at the second time point, and a third location of the satellite at the third time point, based on the first broadcast message, the second broadcast message, and the third broadcast message, determining a timing advance (TA) value related to a distance between the terminal and the satellite, based on the first location, the second location, and the third location, adjusting a transmission time point of an initial message for initial access to the satellite, based on the determined TA value, and transmitting the initial message to the satellite at the adjusted transmission time point.

In accordance with an aspect of the disclosure, a terminal of an NTN includes a transceiver, and at least one processor connected to the transceiver and configured to receive a first broadcast message comprising at least part of synchronization information from a satellite at a first time point, receive a second broadcast message comprising a remainder of the synchronization information from the satellite at a second time point, receive a third broadcast message comprising location information related to a location of the satellite from the satellite at a third time point, determine a first location of the satellite at the first time point, a second location of the satellite at the second time point, and a third location of the satellite at the third time point, based on the first broadcast message, the second broadcast message, and the third broadcast message, determine a TA value related to a distance between the terminal and the satellite, based on the first location, the second location, and the third location, adjust a transmission time point of an initial message for initial access to the satellite, based on the determined TA value, and transmit the initial message to the satellite at the adjusted transmission time point.

In accordance with an aspect of the disclosure, a communication method of a satellite in an NTN includes transmitting a first broadcast message comprising at least part of synchronization information from the satellite at a first time point, transmitting a second broadcast message comprising a remainder of the synchronization information from the satellite at a second time point, transmitting a third broadcast message comprising location information related to a location of the satellite from the satellite at a third time point, and receiving an initial message for initial access from a terminal at a time adjusted according to a TA value determined based on a first location of the satellite at the first time point, a second location of the satellite at the second time point, and a third location of the satellite at the third time point, wherein the first location of the satellite at the first time point, the second location of the satellite at the second time point, and the third location of the satellite at the third time point are determined based on the first broadcast message, the second broadcast message, and the third broadcast message.

In accordance with an aspect of the disclosure, a satellite of an NTN includes a transceiver, and at least one processor connected to the transceiver and configured to transmit a first broadcast message comprising at least part of synchronization information from the satellite at a first time point, transmit a second broadcast message comprising a remainder of the synchronization information from the satellite at a second time point, transmit a third broadcast message comprising location information related to a location of the satellite from the satellite at a third time point, and receive an initial message for initial access from a terminal at a time adjusted according to a TA value determined based on a first location of the satellite at the first time point, a second location of the satellite at the second time point, and a third location of the satellite at the third time point, wherein the first location of the satellite at the first time point, the second location of the satellite at the second time point, and the third location of the satellite at the third time point are determined based on the first broadcast message, the second broadcast message, and the third broadcast message.

### BRIEF DESCRIPTION OF THE DRAWINGS

The above and other aspects, features, and advantages of certain embodiments will be more apparent from the following description taken in conjunction with the accompanying drawings, in which:

FIG. 1 illustrates a basic structure of a time-frequency domain, which is a radio resource domain where data or control information is transmitted in a 5G communication system or a beyond 5G communication system according to an embodiment;

FIG. 2 illustrates a communication system using a satellite, according to an embodiment;

FIG. 3 illustrates coverage of a satellite according to an embodiment;

FIG. 4 illustrates a procedure in which a terminal accesses a satellite in an NTN according to an embodiment;

FIG. 5 illustrates a TA performed for UL synchronization according to an embodiment;

FIG. 6 illustrates an NTN system including a terminal and a satellite, according to an embodiment;

FIG. 7 illustrates a terminal, according to an embodiment;

FIG. 8 illustrates a communication method of a terminal in an NTN system, according to an embodiment;

FIG. 9 illustrates an example where a terminal receives a plurality of broadcast messages from a satellite as time passes, according to an embodiment;

FIG. 10 illustrates an example where a terminal calculates a distance between the terminal and a satellite, according to an embodiment;

FIG. 11 illustrates an example where a distance between a terminal and a satellite is calculated, according to an embodiment;

FIG. 12 illustrates an example where a distance between a terminal and a satellite is calculated, according to an embodiment;

FIG. 13 illustrates a process in which a terminal calculates a TA value, according to an embodiment;

FIG. 14 illustrates a broadcast message used from among a plurality of broadcast messages according to a time point at which each of a plurality of terminals enters an NTN, according to an embodiment;

FIG. 15 illustrates an example where a terminal using a broadcast message information differential management method receives a plurality of broadcast messages, according to an embodiment;

FIG. 16 illustrates a representative TA difference value received by a terminal in an earth-moving cell, according to an embodiment;

FIG. 17 illustrates a representative TA value received by a terminal in a quasi earth-fixed cell, according to an embodiment;

FIG. 18 is a graph showing a representative TA difference value of a terminal in a quasi earth-fixed cell, according to an embodiment; and

FIG. 19 illustrates a satellite, according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

Throughout the disclosure, the expression “at least one of a, b or c” indicates only a, only b, only c, both a and b, both a and c, both b and c, all of a, b, and c, or variations thereof. Throughout the specification, a layer may also be referred to as an entity.

The terms used herein are widely used in the art in consideration of their functions but may vary according to the intention of one of ordinary skill in the art, precedents, or new technology in the art. Some terms may be arbitrarily selected by the applicant. In this case, the meaning of the selected terms will be described in detail herein. Accordingly, the specific terms used herein should be defined based on the unique meanings thereof and the entire context of the disclosure.

When a portion “includes” an element, another element may be further included, rather than excluding the existence of the other element, unless otherwise described. Also, the terms such as “ . . . unit” or “module” refer to units that perform at least one function or operation, and the units may be implemented as hardware or software or as a combination of hardware and software.

Hereinafter, higher layer signaling refers to a method of transmitting a signal from a base station to a terminal by using a DL data channel of a physical layer or transmitting a signal from a terminal to a base station by using an UL data channel of a physical layer. Higher layer signaling may be radio resource control (RRC) signaling or media access control (MAC) control element (CE).

Some terms and names defined in the 3^{rd} generation partnership project long term evolution (3GPP LTE) standard may be used herein for convenience of explanation. However, the disclosure may not be limited to the terms and names and may also be applied to systems following other standards.

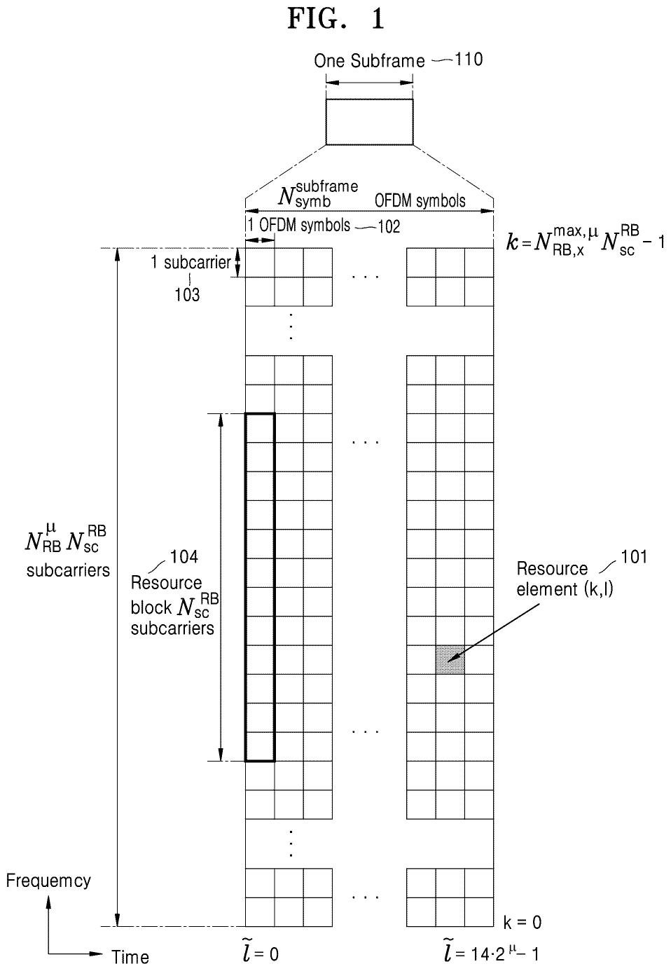

FIG. 1 illustrates a basic structure of a time-frequency domain, which is a radio resource domain where data or control information is transmitted in a 5G or beyond 5G communication system according to an embodiment.

Referring to FIG. 1, the horizontal axis represents a time domain, and the vertical axis represents a frequency domain. Resource element 101 may be defined in the time domain and the frequency domain. A minimum transmission unit in the time domain is an OFDM symbol, and N_{symb} OFDM symbols 102 constitute one slot 106. A length of a subframe is defined as 1.0 milliseconds (ms), and a radio frame 114 is defined as 10 ms. A minimum transmission unit in the frequency domain is a subcarrier 103, and a transmission bandwidth of an entire system may include NRB subcarriers 104 in total. Specific numerical values such as N_{symb} and N_{BW} may vary according to a system. One frame may be defined as 10 ms. One subframe 110 may be defined as 1 ms. Therefore, one frame may include a total of 10 subframes. One slot may be defined as 14 OFDM symbols (i.e., the number of symbols per slot N^{slot}_{symb}=14). One subframe may include one or more slots, and the number of slots per subframe may vary according to a configuration value μ for a subcarrier spacing.

When μ=0, one subframe may include one slot, and when μ=1, one subframe may include two slots. That is, the number of slots per subframe N^{subframe}ₛₗₒₜ may vary according to the configuration value μ for the subcarrier spacing. Therefore, the number of slots per frame N^{frame}ₛₗₒₜ may vary. N^{subframe}ₛₗₒₜ and N^{frame}ₛₗₒₜ according to each subcarrier spacing configuration value μ may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

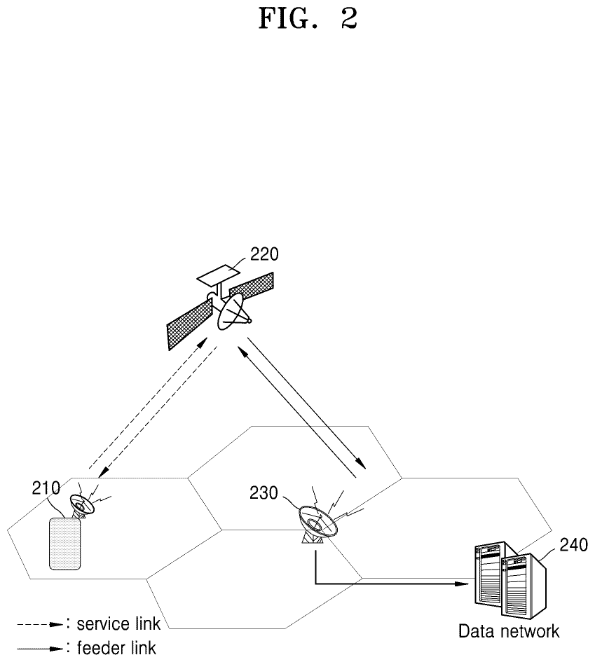

FIG. 2 illustrates a communication system using a satellite, according to an embodiment.

Satellites for communication may be classified into a low earth orbit (LEO) satellite, a middle earth orbit (MEO) satellite, and a geostationary earth orbit (GEO) satellite according to an orbit of a satellite. In general, the GEO satellite has an altitude of about 36000 kilometers (km), the MEO satellite has an altitude of about 5000 km to about 15000 km, and the LEO satellite has an altitude of about 500 km to about 1000 km. An orbital period around the Earth varies according to each altitude. An orbital period of the GEO satellite around the earth is about 24 hours, an orbital period of the MEO satellite 1110 is about 6 hours, and an orbital period of the LEO satellite 1130 is about 90 minutes to about 120 minutes. The LEO satellite (˜2,000 km) orbits at a relatively low altitude and thus, may be advantageous over the GEO satellite (36,000 km) in terms of propagation delay and loss.

A satellite may be transparent and function as a transponder for frequency conversion and amplification functions of a service link and a feeder link, or a re-generative satellite (on-board processing (OBP) satellite) performing a function of a next generation node B (gNB) which is a base station in a terrestrial network. According to each satellite type, a location of the gNB function changes to a section after a gateway or a satellite.

FIG. 2 illustrates an example of a transparent satellite, and a link between a terminal 210 and a satellite 220 is a service link and a link between the satellite 220 and a gateway 230 is a feeder link. For example, when the terminal 210 transmits a signal to the satellite 220 through the service link, the satellite 220 may transmit the received signal to the gateway 230 connected to a data network 240 through the feeder link. The gateway 230 may transmit a signal received from the data network 240 to the satellite 220 through the feeder link, and the satellite 220 may transmit the received signal to the terminal 210 through the service link.

Because a distance between the terminal 210 and the satellite 220 is long (e.g. between 160 km and 2,000 km and a distance between the satellite 220 and the gateway 230 is also long, a time required to transmit and receive data in an NTN is greater than a time required to transmit and receive data in a TN.

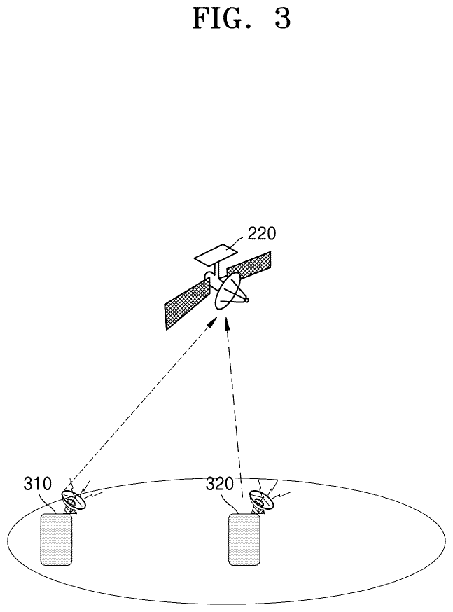

FIG. 3 illustrates coverage of a satellite according to an embodiment.

Herein, a satellite may provide satellite coverage through a plurality of beams, and one beam may correspond to a cell in a terrestrial network.

In a terrestrial network, propagation delay of less than 1 ms occurs. However, in an NTN, propagation delay may be long from several ms to hundreds of ms according to an altitude of a satellite, which is a base station.

Due to these satellite characteristics, a large difference in propagation delay may occur between terminals, particularly, in a UL. For example, referring to FIG. 3, a beam radius (e.g., a cell radius) is 20 km, a difference in a round-trip delay time to a satellite between terminals 310 and 320 at different locations within a beam according to a location of the satellite may be less than or equal to about 0.28 ms.

Accordingly, to perform synchronization between a terminal and a base station, a TA application method considering an NTN environment is required.

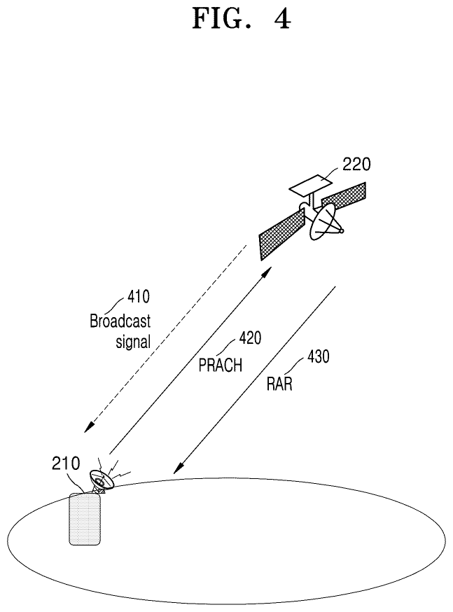

FIG. 4 illustrates a procedure in which a terminal accesses a satellite in an NTN according to an embodiment.

Referring to FIG. 4, in step 410, the terminal 210 may receive a signal broadcast from the satellite 220. The signal broadcast from the satellite 220 may include a synchronization signal and system information.

The synchronization signal may include a primary synchronization signal (PSS), a secondary synchronization signal (SSS), and a physical broadcast channel (PBCH). For example, in a 5G system, an SS/PBCH block including a PSS, an SSS, and a PBCH is used as a synchronization signal. Each of the PSS, the SSS, and the PBCH may provide the following information.

The PSS is a reference signal for DL time/frequency synchronization, which provides some formation of a cell ID.

The SSS is a reference signal for DL time/frequency synchronization, which provides the remaining information of the cell ID which is not provided by the PSS. Additionally, the SSS may be used as another reference signal for demodulation of the PBCH.

The PBCH is a channel for providing essential system information required for transmission and reception of a data channel and a control channel of a terminal. The essential system information may include search space-related control information indicating radio resource mapping information of the control channel, and scheduling control information for a separate data channel that transmits system information.

The SS/PBCH block is a combination of the PSS, the SSS, and the PBCH. One or more SS/PBCH blocks may be transmitted within 5 ms, and each of the transmitted SS/PBCH blocks may be distinguished by an index.

The terminal 210 may detect the PSS and the SSS in an initial access stage and may decode the PBCH. The terminal 210 may obtain a master information block (MIB) from the PBCH and may receive configuration information for a search space and a control resource set (CORESET) where a physical DL control channel (PDCCH) may be transmitted to receive system information (e.g., remaining system information (RMSI) or system information block 1 (SIB1)) required for initial access through the MIB. In this case, the CORESET may be a CORESET #0 with an index of 0, and the terminal may receive system information by using DL control information transmitted in the CORESET #0. For example, the terminal may receive an SIB1 message and an SIB19 message. The terminal may obtain random access channel (RACH)-related configuration information required for initial access from the received system information.

In step 420, the terminal 210 may transmit a preamble through a physical RACH (PRACH). For example, the terminal 210 may transmit an initial message msg1 including the preamble through the PRACH. The terminal 210 may transmit the preamble in a random access resource identified based on the RACH-related configuration information. Preambles may be a signal determined based on information configured in step 410 by using a pre-determined sequence. For example, preambles may have a pre-determined amplitude, frequency, and/or waveform and notifying the satellite 220 that the information configured in step 410 has been reflected. The satellite 220 may receive the preamble transmitted by the terminal. A base station may attempt to receive each of preambles that may be configured in a random access resource configured by the base station, without knowing which terminal has sent the preamble. When the base station determines that a specific preamble from among the preambles that may be configured has been received, the base station may determine that at least one terminal has transmitted the specific preamble.

In step 430, the terminal 210 may receive a random access response (RAR) from the satellite 220. Information about a TA value to be applied for communication between the terminal 210 and the satellite 220 may be included in the RAR.

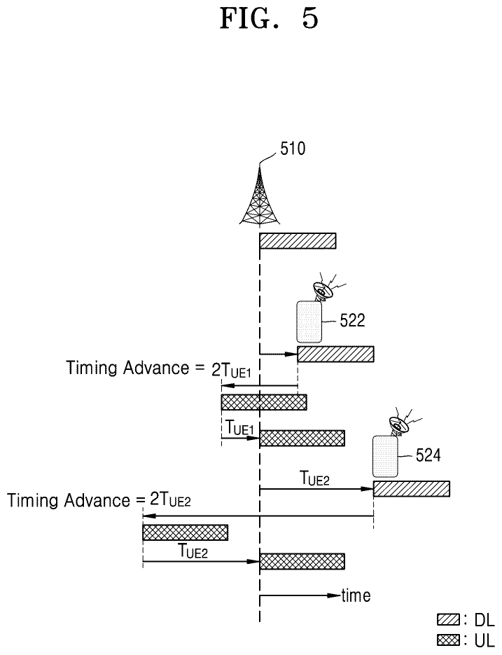

FIG. 5 illustrates TA performed for UL synchronization according to an embodiment.

A base station may provide a communication service to at least one terminal. A communication link provided from the base station to the terminal for the communication service may be a DL and a communication link provided from the terminal to the base station may be a UL.

Referring to FIG. 5, time synchronization should be achieved to smoothly provide a communication service between a base station 510 and terminals 522 and 524. The terminals 522 and 524 may perform DL synchronization by using a synchronization signal broadcast from the base station 510. In the case of a UL, because locations of the terminals 522 and 5245 transmitting signals to the base station 510 are different, different UL propagation delays may occur according to locations of the terminals 522 and 524. For UL signals of the terminal 522 and 524 received by the base station 510 to be aligned on a time axis, it is necessary to transmit a UL signal by applying a TA value in consideration of propagation delay of each of the terminals 522 and 524.

A TA value may be determined to be twice a propagation delay value between the base station 510 and the terminals 522 and 524. The base station may determine a TA value for each of the terminals 522 and 524 by using preambles received from the terminals 522 and 524. For example, when the base station succeeds in detecting a preamble transmitted by the first terminal 522, the base station may determine that a TA value is 2T_{UE1} based on a time when the detected preamble is received by the base station. When the base station succeeds in detecting a preamble transmitted by the second terminal 524, the base station may determine that a TA value is 2T_{UE2} based on a time when the detected preamble is received by the base station.

The base station 510 may be implemented as a satellite in an NTN. The base station 510 may provide the TA value determined for each of the terminals 522 and 524 to each of the terminals 522 and 524 through an RAR described with reference to FIG. 4. When each of the terminals 522 and 524 transmits a signal by the TA value earlier than a DL time aligned through a synchronization signal of the base station 510, UL signals of the terminals 522 and 524 reaching the base station 510 may be aligned.

A communication method of a terminal, the terminal, a communication method of a satellite, and the satellite in an NTN system aim to enable synchronization and initial access between a terminal and a satellite without the help of a global navigation system.

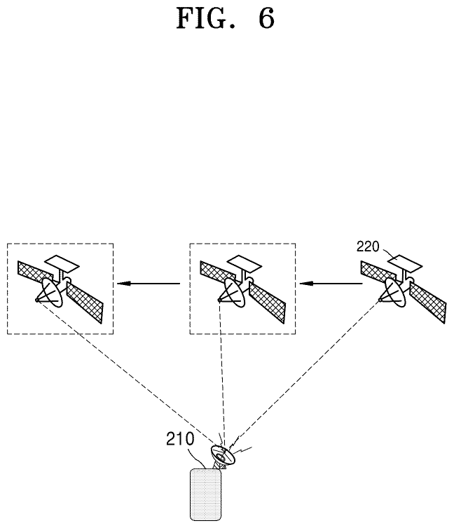

FIG. 6 illustrates an NTN system including the terminal 210 and the satellite 220, according to an embedment.

Referring to FIG. 6, the terminal 210 may be connected to the satellite 220. The terminal 210 may support direct communication with the satellite 220 through an NTN. Accordingly, the terminal 210 may not require a base station on the ground when connected to the satellite 220. The terminal 210 may establish a link with the satellite 220. For example, the terminal 210 may establish a service link for 5G new radio (NR) and/or 6G communication.

The satellite 220 may be connected to the terminal 210 and may move while rotating around the earth. As the satellite 20 moves, a location of the satellite 220 with respect to the terminal 210 may change. As shown in FIG. 6, due to the mobility of the satellite 220, a location of the satellite 220 with respect to the terminal 210 may change as time passes. The satellite 220 may transmit a first broadcast message, a second broadcast message, and a third broadcast message.

At least one of the first broadcast message, the second broadcast message, or the third broadcast message may include synchronization information. The synchronization information may be information for achieving time synchronization between the satellite 220 or a base station and the terminal 210.

At least one of the first broadcast message, the second broadcast message, or the third broadcast message may include satellite location information. The satellite location information may include a first location of the satellite 220 at a first time point when the satellite 220 transmits the first broadcast message, a second location of the satellite 220 at a second time point when the satellite 220 transmits the second broadcast message, and a third location of the satellite 220 at a third time point when the satellite 220 transmits the third broadcast message.

At least one of the first broadcast message, the second broadcast message, or the third broadcast message may include time interval information. The time interval information may include a first time interval between the first time point and the second time point. The time interval information may include a second time interval between the second time point and the third time point.

The terminal 210 may receive, from the satellite 220, the first broadcast message, the second broadcast message, and the third broadcast message. The terminal 210 may obtain the synchronization information, the satellite location information, and the time interval information based on the first broadcast message, the second broadcast message, and the third broadcast message. The terminal 210 may obtain a first reception time, a second reception time, and a third reception time which are reception times of the first broadcast message, the second broadcast message, and the third broadcast message. The terminal 210 may obtain a first reception interval between the first reception time and the second reception time. The terminal 210 may obtain a second reception interval between the second reception time and the third reception time.

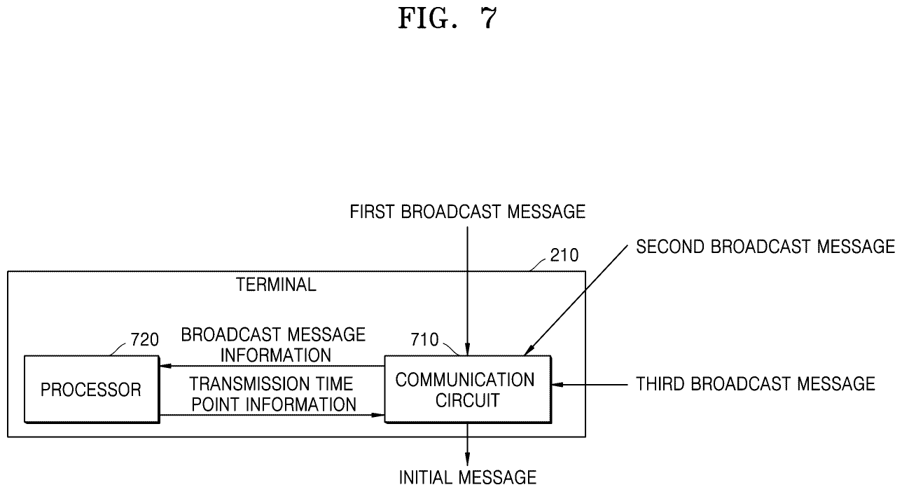

FIG. 7 illustrates the terminal 210, according to an embodiment. The terminal 210 may be connected to a satellite (e.g., the satellite 220 of FIG. 6) through an NTN.

Referring to FIG. 7, the terminal 210 may include a communication circuit 710 and at least one processor 720. The communication circuit 710 may include an antenna, an amplifier, and a transfer circuit. However, this is only an example, and elements of the communication circuit 710 are not limited thereto and the communication circuit 710 may include more or fewer elements than those described above. The antenna may receive an external signal or may transmit a channel signal generated by the at least one processor 720 to the outside. The amplifier may amplify the external signal received by the antenna or the channel signal generated by the at least one processor 720. The transfer circuit may transmit the external signal received by the antenna to the at least one processor 720 or may transmit the channel signal generated by the at least one processor 720 to the antenna. The communication circuit 710 may be described as a transceiver in the disclosure.

The at least one processor 720 may be electrically connected to the communication circuit 710, may receive a signal received and amplified by the communication circuit 710, may process the signal received from the communication circuit 710, may generate a channel signal based on a result of processing the signal received from the communication circuit 710 and may transmit the channel signal to the communication circuit 710.

The communication circuit 710 may receive a first broadcast message, a second broadcast message, and a third broadcast message. The first broadcast message, the second broadcast message, and the third broadcast message may be transmitted from the satellite 220. The at least one processor 720 may control the communication circuit 710 to receive the first broadcast message, the second broadcast message, and the third broadcast message.

The first broadcast message may include at least part of synchronization information. For example, the first broadcast message may be a synchronization signal block (SSB) message+an MIB message. The second broadcast message may include the remainder of the synchronization information. For example, the second broadcast message may be an SIB1 message. The third broadcast message may include location information related to a location of the satellite 220. For example, the third broadcast message may be an SIB19 message.

The first broadcast message, the second broadcast message, and the third broadcast message may be transmitted from the satellite 220 at different time points. The communication circuit 710 may receive the first broadcast message, the second broadcast message, and the third broadcast message at different time points. That is, the communication circuit 710 may receive the first broadcast message at a first time point, may receive the second broadcast message at a second time point, and may receive the third broadcast message at a third time point.

The communication circuit 710 may transmit broadcast message information including the first broadcast message, the second broadcast message, and the third broadcast message to the at least one processor 720 which may receive the broadcast message information from the communication circuit 710.

The at least one processor 720 may determine a first location of the satellite 220 at the first time point, a second location of the satellite 220 at the second time point, and a third location of the satellite 220 at the third time point, based on the first broadcast message, the second broadcast message, and the third broadcast message included in the broadcast message information.

The at least one processor 720 may determine a TA value related to a distance between the terminal 210 and the satellite 220, based on the first location, the second location, and the third location. The at least one processor 720 may calculate a distance between the terminal 210 and the satellite 220 based on the first location, the second location, and the third location. The at least one processor 720 may determine a value obtained by dividing a distance between the terminal 210 and the satellite 220 by the speed of light as a TA value.

The at least one processor 720 may adjust a transmission time point of an initial message for initial access to the satellite 220, based on the determined TA value. The at least one processor 720 may advance the transmission time point of the initial message by the determined TA value.

The at least one processor 720 may control the communication circuit 710 to transmit the initial message to the satellite 220 at the adjusted time point. The at least one processor 720 may transmit, to the communication circuit 710, transmission time point information indicating that the transmission time point of the initial message is advanced by the determined TA value. The communication circuit 710 may transmit the initial message to the satellite 220 at the adjusted transmission time point corresponding to the received transmission time point information.

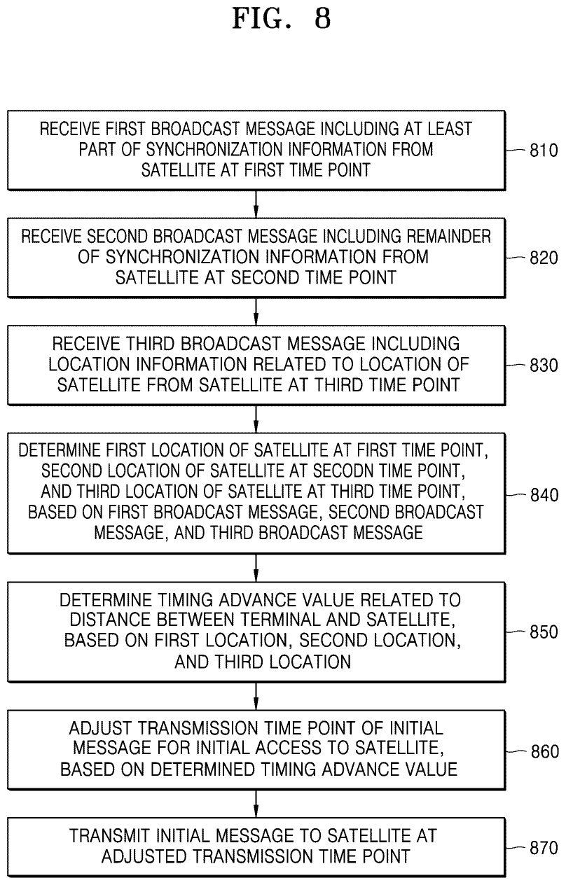

FIG. 8 illustrates a communication method of a terminal in an NTN system, according to an embodiment.

In step 810, the terminal 210 may receive a first broadcast message including at least part of synchronization information from the satellite 220 at a first time point.

In step 820, the terminal 210 may receive a second broadcast message including the remainder of the synchronization information from the satellite 220 at a second time point.

In step 830, the terminal 210 may receive a third broadcast message including location information related to a location of a satellite from the satellite 220 at a third time point.

In step 840, the terminal 210 may determine a first location of the satellite 220 at the first time point, a second location of the satellite 220 at the second time point, and a third location of the satellite 220 at the third time point, based on the first broadcast message, the second broadcast message, and the third broadcast message.

In step 850, the terminal 210 may determine a TA value related to a distance between the terminal 210 and the satellite 220, based on the first location, the second location, and the third location.

In step 860, the terminal 210 may adjust a transmission time point of an initial message for initial access to the satellite 220, based on the determined TA value.

In step 870, the terminal 210 may transmit the initial message to the satellite 220 at the adjusted transmission time point.

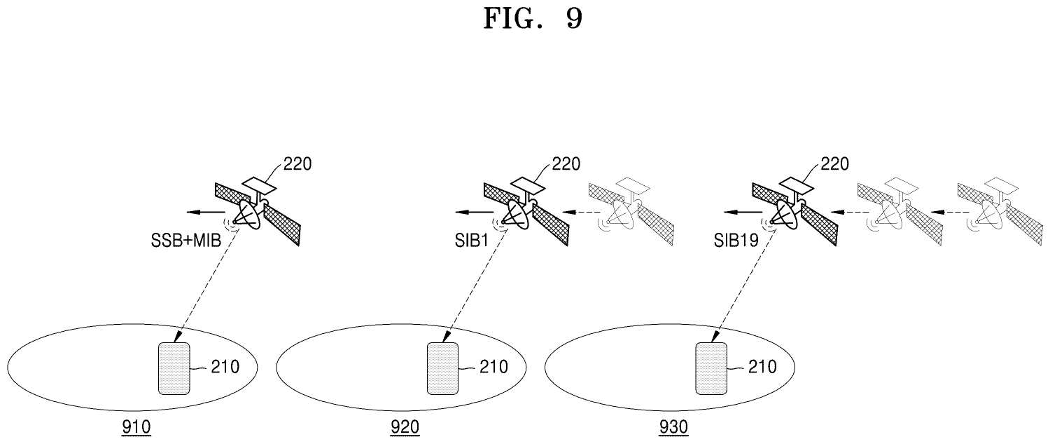

FIG. 9 illustrates an example where the terminal 210 receives a plurality of broadcast messages from the satellite 220 as time passes, according to an embodiment.

Referring to FIG. 9, the terminal 210 attempts to calculate a TA value based on information included in broadcast messages before performing initial access. The terminal 210 may determine a transmission time point of an initial message msg1 transmitted through a RACH, based on the calculated TA value. When the terminal 210 accesses the satellite 220 according to a 4-step initial access procedure, the initial message msg1 may include a preamble. Alternatively, when the terminal 210 accesses the satellite 220 according to a 2-step initial access procedure, the initial message msg1 may include a preamble and data.

The terminal 210 may receive a plurality of broadcast messages including information of the satellite 220 and location information of the satellite 220 of at transmission time point of the plurality of broadcast messages. The plurality of broadcast messages including the information of the satellite 220 may include at least three pieces of information related to the satellite 220.

At a first time point 910, the terminal 210 may receive a first broadcast message from the satellite. The first broadcast message may be an SSB message+an MIB message. The first broadcast message may include at least part of synchronization information. The plurality of broadcast messages including the information of the satellite 220 may include the first broadcast message that is received before at least one broadcast message including location information and is for performing synchronization.

At a second time point 920, the terminal 210 may receive a second broadcast message from the satellite. The second broadcast message may be an SIB1 message. The second broadcast message may include the remainder of the synchronization information. The plurality of broadcast messages including the information of the satellite 220 may include a broadcast message received at a different time point from the first broadcast message.

At a third time point 930, the terminal 210 may receive a third broadcast message from the satellite. The third broadcast message may be an SIB19 message. The third broadcast message may include location information related to a location of the satellite 220. The plurality of broadcast messages including the information of the satellite 220 may include the third broadcast message including location information related to a location of the satellite 220.

The terminal 210 may receive information about a time interval between time points when the first broadcast message, the second broadcast message, and the third broadcast message included in the plurality of broadcast messages including the information of the satellite 220 are transmitted from the satellite 220. The plurality of broadcast messages including the information of the satellite 220 may include time interval information between a time point when the first broadcast message is transmitted from the satellite 220 and a time point when the second broadcast message is transmitted from the satellite 220. The plurality of broadcast messages including the information of the satellite 220 may include time interval information between a time point when the second broadcast message is transmitted form the satellite 220 and a time point when the third broadcast message is transmitted from the satellite 220.

The terminal 210 may obtain information about a time point when each of the first broadcast message, the second broadcast message, and the third broadcast message is received. For example, the terminal 210 may record a time point when each of the first broadcast message, the second broadcast message, and the third broadcast message is received and may store the recorded time point in a memory. For example, the terminal 210 may calculate a time point when each of the first broadcast message, the second broadcast message, and the third broadcast message is received, based on the synchronization information included in the first broadcast message and the second broadcast message. For example, the terminal 210 may measure and record a time immediately upon receiving each of the first broadcast message, the second broadcast message, and the third broadcast message and may calculate a time point when each of the first broadcast message, the second broadcast message, and the third broadcast message is received.

In summary, the terminal 210 may receive three broadcast messages transmitted at different time points from the same satellite, may obtain the following information included in the three broadcast messages to calculate a TA value, and may adjust an initial message transmission time point based on the calculated TA value.
(1) location information of the satellite 220 transmitting each broadcast message at a time point when each of the three broadcast messages received by the terminal 210 is transmitted
(2) a transmission time interval at the satellite 220 between the three broadcast messages received by the terminal 210
(3) a reception time interval at the terminal 210 between the three broadcast messages received by the terminal 210

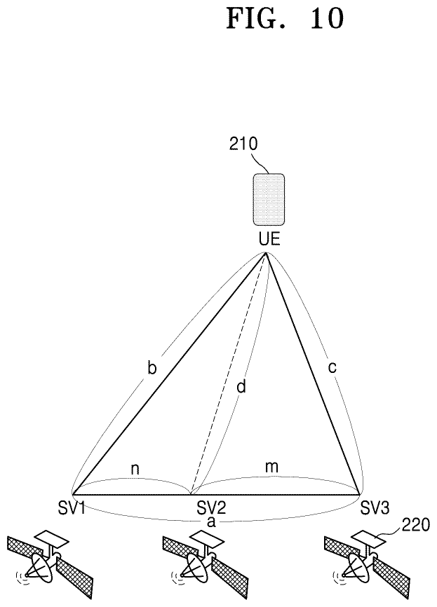

FIG. 10 illustrates an example where the terminal 210 calculates a distance between the terminal 210 and the satellite 220, according to an embodiment.

Referring to FIG. 10, the terminal 210 may assume that the satellite 220 linearly moves. When the satellite 220 transmits broadcast messages while moving, the terminal 210 may calculate, based on a time point when each of a first broadcast message, a second broadcast message, and a third broadcast message is transmitted from the satellite 220 and a time point when each of the first broadcast message, the second broadcast message, and the third broadcast message is received by the terminal 210, a location of the satellite 220 when each of the first broadcast message, the second broadcast message, and the third broadcast message is transmitted. A location of the satellite 220 when the first broadcast message is transmitted may be referred to as a first satellite vehicle (SV) SV1. A location of the satellite 220 when the second broadcast message is transmitted may be referred to as SV2. A location of the satellite 220 when the third broadcast message is transmitted may be referred to as SV3. The terminal 210 may calculate a distance between the terminal 210 and the satellite 220 based on SV1, SV2, and SV3. The terminal 210 may calculate a distance between the terminal 210 and the satellite 220 based on Stewart's theorem. Stewart's theorem may be defined as Equation (1) below.

$$m {b}^{2} + n {c}^{2} = ( m + n ) ( m n + {d}^{2} ) = a ( m n + {d}^{2} ) \qquad ( 1 )$$

In Equation (1), m may be a distance between SV2 and SV3. In Equation (1), m may be a distance between SV2 and SV3. In Equation (1), n may be a distance between SV1 and SV2. In Equation (1), a may be a distance between SV1 and SV3. In Equation (1), b may be a distance between SV1 and the terminal 210. In Equation (1), c may be a distance between SV3 and the terminal 210. In Equation (1), d may be a distance between SV2 and the terminal 210. The terminal 210 may calculate a distance between the terminal 210 and the satellite 220 by using Equation (1) and already known information.

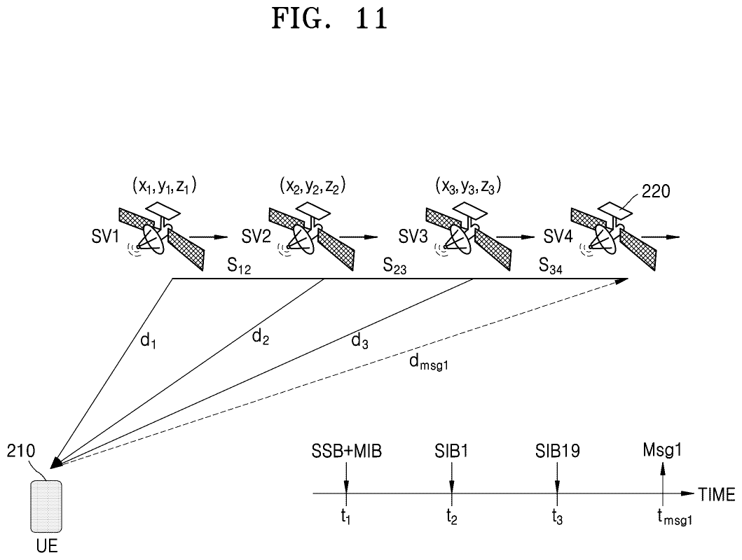

FIG. 11 illustrates an example where a distance between the terminal 210 and the satellite 220 is calculated, according to an embodiment.

Referring to FIG. 11, the satellite 220 may be located at SV1 (x₁, y₁, z₁) at a first time point t₁. The satellite 220 may be located at SV2 (x₂, y₂, z₂) at a second time point t₂. The satellite 220 may be located at SV3 (x₃, y₃, z₃) at a third time point t₃. The satellite 220 may be located at SV3 (x₃, y₃, z₃) at the third time point t₃. The satellite 220 may be located at SV4 (x₄, y₄, z₄) at an initial message transmission time point t_{msg1} when the terminal 210 transmits an initial message msg1.

The terminal 210 may receive a first broadcast message SSB+MIB at the first time point t₁. The terminal 210 may receive a second broadcast message SIB1 at the second time point t₂. The terminal 210 may receive a third broadcast message SIB19 at the third time point t₃. The terminal 210 may transmit the initial message msg1 at the initial message transmission time point t_{msg1}.

At the first time point t₁, a distance between the terminal 210 and the satellite 220 (SV1) may be a first distance d1. At the second time point t₂, a distance between the terminal 210 and the satellite 220 (SV2) may be a second distance d2. At the third time point t₃, a distance between the terminal 210 and the satellite 220 (SV3) may be a third distance d3. At the initial message transmission time point t_{msg1}, a distance between the terminal 210 and the satellite 220 (SV4) may be an initial message transmission distance d_{msg1}.

The satellite 220 may transmit the first broadcast message SSB+MIB and the second broadcast message SIB1 at a first time interval i₁₂. The satellite 220 may transmit the second broadcast message SIB1 and the third broadcast message SIB19 at a second time interval i₂₃.

The second distance d2 and the third distance d3 may be expressed in Equation (2) and Equation (3) below by using the first distance d1, the first time point t₁, the second time point t₂, the third time point t₃, the first time interval i₁₂, the second time interval i₂₃, and a speed of light c.

$$d 2 = d 1 + c ( {t}_{2} - {t}_{1} - {i}_{12} ) \qquad ( 2 )$$

$$d 3 = d 1 + c ( {t}_{2} - {t}_{1} - {i}_{12} ) + c ( {t}_{3} - {t}_{2} - {i}_{23} ) \qquad ( 3 )$$

A distance s₁₂ by which the satellite 220 moves from the first time point t₁ to the second time point t₂ and a distance s₂₃ by which the satellite 220 moves from the second time point t₂ to the third time point t₃ may be expressed in Equation (4) and Equation (5) below by using SV1 (x₁, y₁, z₁), SV2 (x₂, y₂, z₂), and SV3 (x₃, y₃, z₃).

$${s}_{12} = {\{ ( {x}_{2} - {x}_{1} ) + ( {y}_{2} - {y}_{1} ) + ( {z}_{2} - {z}_{1} ) \}}^{1 / 2} \qquad ( 4 )$$

$${s}_{23} = {\{ ( {x}_{3} - {x}_{2} ) + ( {y}_{3} - {y}_{2} ) + ( {z}_{3} - {z}_{2} ) \}}^{1 / 2} \qquad ( 5 )$$

The terminal 210 may calculate the first distance d1 in Equation (6) below by using Equation (1) according to Stewart's Theorem.

$${s}_{23} {d}_{1}^{2} + {{s}_{12} ( {d}_{1} + c ( {t}_{2} - {t}_{1} - {i}_{12} ) + c ( {t}_{3} - {t}_{2} - {i}_{23} ) )}^{2} = ( {s}_{12} + {s}_{23} ) ( {s}_{12} {s}_{23} + {( {d}_{1} + c ( {t}_{2} - {t}_{1} - {i}_{12} ) )}^{2} ) \qquad ( 6 )$$

A distance s₃₄ by which the satellite 220 moves from the third time point t₃ to the initial message transmission time point t_{msg1} may be expressed in Equation (7) below by using s₁₂, s₂₃, the first time point t₁, the third time point t₃, and the initial message transmission time point t_{msg1}.

$${s}_{34} = ( {s}_{12} + {s}_{23} ) ( {t}_{msg 1} - {t}_{3} ) / ( {t}_{3} - {t}_{1} ) \qquad ( 7 )$$

The terminal 210 may calculate the initial message transmission distance d_{msg1} in Equation (8) below by using Equation (1) according to Stewart's Theorem.

$${s}_{34} {d}_{1} + ( {s}_{12} + {s}_{23} ) {d}_{m s g 1}^{2} = ( {s}_{12} + {s}_{23} + {s}_{34} ) ( {s}_{12} + {s}_{23} + {s}_{34} + {( {d}_{1} + c ( {t}_{2} - {t}_{1} - {i}_{12} ) + c ( {t}_{3} - {t}_{2} - {i}_{23} ) )}^{2} ) \qquad ( 8 )$$

The terminal 210 may calculate a value obtained by dividing the initial message transmission distance d_{msg1} by the speed of light c as a TA value. The terminal 210 may pre-compensate for a transmission time point of the initial message msg1 by the TA value.

To apply a method of calculating a TA value described with reference to FIG. 11, time interval information between three broadcast messages transmitted by the satellite 220 is required, and the time interval information should be included in at least one of the three broadcast messages.

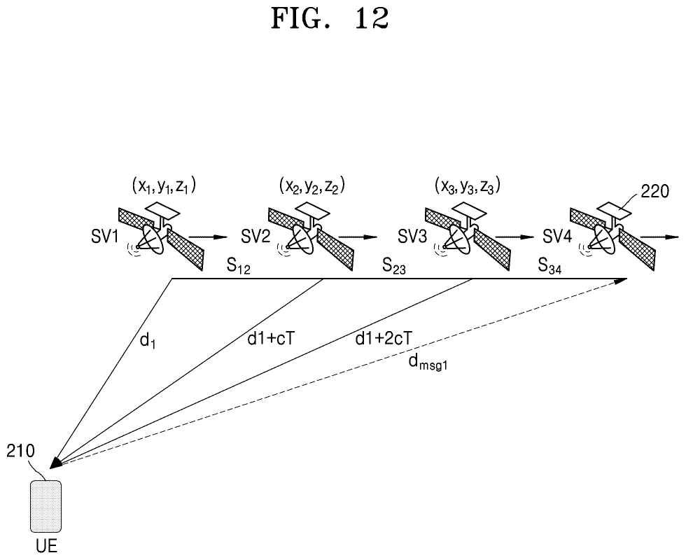

FIG. 12 illustrates an example where a distance between the terminal 210 and the satellite 220 is calculated, according to an embodiment.

Referring to FIG. 12, the terminal 210 may set a time interval at which the satellite 220 transmits the first broadcast message SSB+MIB and the second broadcast message SIB1 and a time interval at which the satellite 220 transmits the second broadcast message SIB1 and the third broadcast message SIB19 to the same value. A time interval i₁₂₃ at which the satellite 220 transmits three broadcast messages may be expressed in Equation (9) below by using the first time point t₁, the second time point t₂, and the third time point t₃.

$${i}_{123} = ( {t}_{3} - {t}_{2} ) - ( {t}_{2} - {t}_{1} ) \qquad ( 9 )$$

The second distance d2 and the third distance d3 may be expressed in Equation (10) and Equation (11) below by using the first distance d1, the first time point t₁, the second time point t₂, the third time point t₃, the time interval i₁₂₃, and the speed of light c.

$$d 2 = d 1 + c * {i}_{123} \qquad ( 10 )$$

$$d 3 = d 1 + 2 c * {i}_{123} \qquad ( ( 11 )$$

The terminal 210 may calculate the first distance d1 in Equation (12) below by using Equation (1) according to Stewart's theorem.

$${s}_{23} {d}_{1}^{2} + {{s}_{12} ( {d}_{1} + 2 c \times {i}_{123} )}^{2} = ( {s}_{12} + {s}_{23} ) ( {s}_{12} {s}_{23} + {( {d}_{1} + c \times {i}_{123} )}^{2} ) \qquad ( 12 )$$

The distance s₃₄ by which the satellite 220 moves from the third time point t₃ to the initial message transmission time point t_{msg1} may be expressed in Equation (13) below by using s₁₂, s₂₃, the first time point t₁, the third time point t₃, and the initial message transmission time point t_{msg1}.

$${s}_{34} = ( {s}_{12} + {s}_{23} ) ( {t}_{msg 1} - {t}_{3} ) / ( {t}_{3} - {t}_{1} ) \qquad ( 13 )$$

The terminal 210 may calculate the initial message transmission distance d_{msg1} in Equation (14) below by using Equation (1) according to Stewart's Theorem.

$${s}_{34} {d}_{1} + ( {s}_{12} + {s}_{23} ) {d}_{m s g 1}^{2} = ( {s}_{12} + {s}_{23} + {s}_{34} ) ( {s}_{12} + {s}_{23} + {s}_{34} + {( {d}_{1} + 2 c \times {i}_{123} )}^{2} ) \qquad ( 14 )$$

The terminal 210 may calculate a value obtained by dividing the initial message transmission distance d_{msg1} by the speed of light c as a TA value. The terminal 210 may pre-compensate for a transmission time point of the initial message msg1 by the TA value.

When a method of calculating a TA value described with reference to FIG. 12 is applied, because a time interval between three broadcast messages transmitted by the satellite 220 is set to the same value, time interval information between the three broadcast messages is not required, thereby simplifying a calculation process.

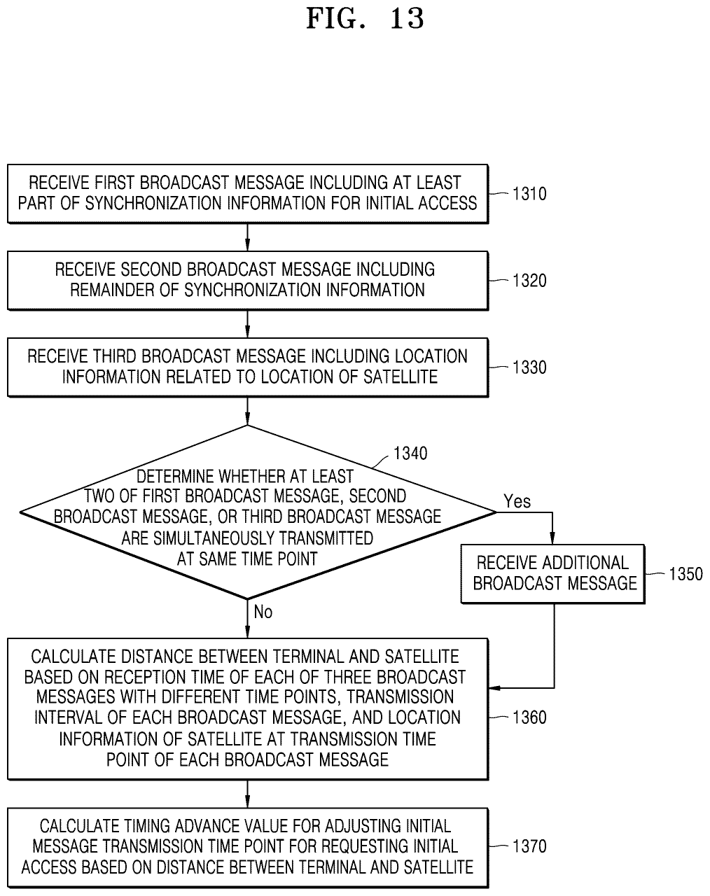

FIG. 13 illustrates a process in which the terminal 210 calculates a TA value, according to an embodiment.

Referring to FIG. 13, in step 1310, the terminal 210 may receive a first broadcast message including at least part of synchronization information for initial access.

In step 1320, the terminal 210 may receive a second broadcast message including the remainder of the synchronization information.

In step 1330, the terminal 210 may receive a third broadcast message including location information related to a location of the satellite 220.

In step 1340, the terminal 210 may determine whether at least two of the first broadcast message, the second broadcast message, or the third broadcast message are simultaneously transmitted at the same time point. When at least two of the first broadcast message, the second broadcast message, or the third broadcast message are simultaneously transmitted at the same time point (Yes in step 1340), the terminal 210 may proceed to step 1350. When all of the first broadcast message, the second broadcast message, and the third broadcast message are transmitted at different time points (No in step 1340), the terminal 210 may proceed to step 1360.

In step 1350, the terminal 210 may receive an additional broadcast message. The terminal 210 may additionally receive the additional broadcast message after receiving the first broadcast message, the second broadcast message, and the third broadcast message. The terminal receiving the additional broadcast message may receive the broadcast message at at least three different time points.

In step 1360, the terminal 210 may calculate a distance between the terminal 210 and the satellite 220 based on a reception time of each of the three broadcast messages with different time points, a transmission interval of each of the broadcast messages, and location information of the satellite 220 at a transmission time point of each of the broadcast messages. The terminal 210 may calculate a distance between the terminal 210 and the satellite 220 at a time point when an initial message is transmitted by using Equation (1) according to Stewart's theorem.

In step 1370, the terminal 210 may calculate a TA value for adjusting an initial message transmission time point for requesting initial access based on the distance between the terminal 210 and the satellite. The terminal 210 may calculate a value obtained by dividing the distance between the terminal 210 and the satellite 220 by a speed of light as a TA value.

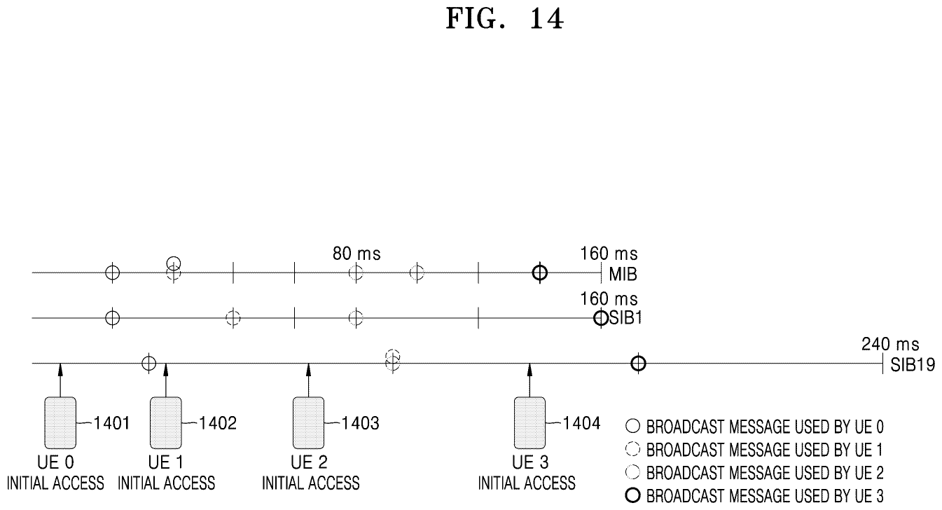

FIG. 14 illustrates a broadcast message used from among a plurality of broadcast messages according to a time point when each of a plurality of terminals enters an NTN, according to an embodiment.

Referring to FIG. 14, an NTN based on existing mobile communication such as LTE or 5G NR may transmit a plurality of different broadcast messages with different contents in the same slot so that the plurality of different broadcast messages are simultaneously transmitted at the same time point. Accordingly, when the terminal 210 receives three broadcast messages, the terminal 210 may simultaneously receive at least two broadcast messages. When the terminal 210 simultaneously receives at least two of the three broadcast messages, the number of broadcast messages of different time points from among the broadcast messages received by the terminal 210 may be 2 or less. When the terminal 210 receives two or less broadcast messages of different time points, the terminal 210 may receive an additional broadcast message and may calculate a TA value after receiving all of the broadcast messages of three different time points.

Broadcast messages may have periodicity and repetition. Periodicity indicates that a new broadcast message is generated in a higher layer and periodically transmitted to a lower layer. Repetition indicates that a lower layer repeatedly receives a broadcast message. Each of a first broadcast message, a second broadcast message, and a third broadcast message may independently have periodicity and repetition. For example, an MIB message corresponding to the first broadcast message may have a periodicity of 80 ms and a repetition of 20 ms. For example, an SIB1 message corresponding to the second broadcast message may have a periodicity of 160 ms and a repetition of 40 ms. For example, an SIB19 message corresponding to the third broadcast message may have a periodicity of 240 ms and a repetition of 80 ms.

Each of a plurality of terminals (e.g., UE0, UE1, UE2, and UE3) may independently receive a plurality of broadcast messages, may receive all of the MIB message, the SIB1 message, and the SIB19 message, and may perform random access (RA) used for initial access and handover based on the received MIB message, SIB1 message, and SIB19 message.

Each of the plurality of terminals (e.g., UE0, UE1, UE2, and UE3) may independently use a plurality of broadcast messages. For example, a 0^{th} terminal UE0 1401 may use the MIB message, the SIB1 message, and the SIB19 message received first after a time point when the 0^{th} terminal UE0 1401 initially accesses an NTN cell. For example, a first terminal UE1 1402 may use the MIB message, the SIB1 message, and the SIB19 message received first after a time point when the first terminal UE1 1402 initially accesses the NTN cell. For example, a second terminal UE2 1403 may use the MIB message, the SIB1 message, and the SIB19 message received first after a time point when the second terminal UE2 1403 initially accesses the NTN cell. For example, a third terminal UE3 1404 may use the MIB message, the SIB1 message, and the SIB19 message received first after a time point when the third terminal UE3 1403 initially accesses the NTN cell.

At least one terminal may receive at least two of the first broadcast message, the second broadcast message, or the third broadcast message in the same slot. For example, the 0^{th} terminal UE0 1401 and the second terminal UE2 1403 may receive, in the same slot, the MIB message and the SIB1 message from among the MIB message, the SIB1 message, and the SIB19 message received after a time point when the 0th terminal UE0 1401 and the second terminal UE2 enter the NTN cell. The 0^{th} terminal UE0 and the second terminal UE2 1403 have received three broadcast messages, but based on a reception time, the 0^{th} terminal UE0 and the second terminal UE2 1403 may be in the same state as receiving two broadcast messages.

When at least one terminal receives at least two broadcast messages in the same slot, the at least one terminal may receive an additional broadcast message after a time point when the first broadcast message, the second broadcast message, and the third broadcast message are received. The additional broadcast message may be a broadcast message received first from among the at least two broadcast messages. For example, after receiving the SIB19 message received last from among the MIB message, the SIB1 message, and the SIB19 message is received, the 0^{th} terminal UE0 1401 and the second terminal UE2 1403 may receive and use, as an additional broadcast message, the MIB message received first from among the MIB message and the SIB1 message received in the same slot.

When at least one terminal receives all of the first broadcast message, the second broadcast message, and the third broadcast message in different slots, the at least one terminal may not receive an additional broadcast message. For example, the first terminal UE1 1402 and the third terminal UE3 1404 may receive all of the MIB message, the SIB1 message, and the SIB19 message in different slots. The first terminal UE1 1402 and the third terminal UE3 1404 do not need to receive an additional broadcast message and thus, may not receive the additional broadcast message.

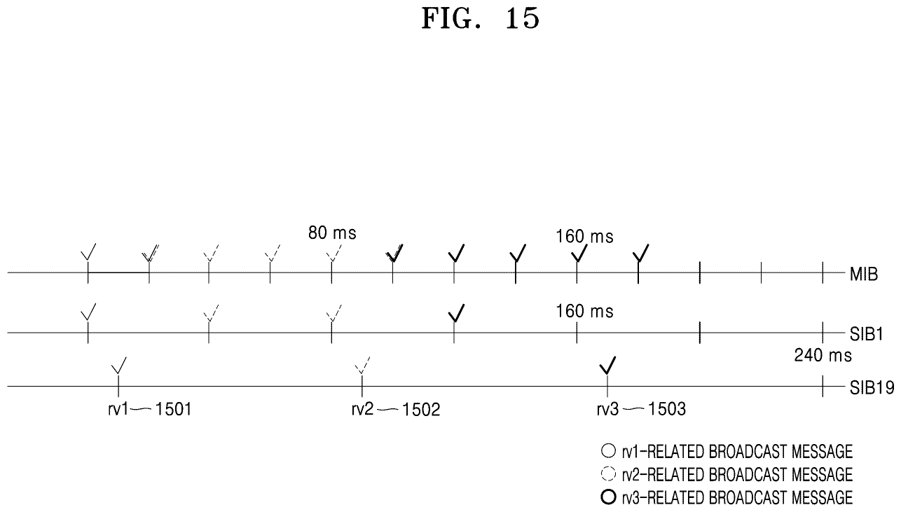

FIG. 15 illustrates an example where the terminal 210 using a broadcast message information differential management method receives a plurality of broadcast messages, according to an embodiment.

Referring to FIG. 15, the satellite 220 or a base station may generate a plurality of broadcast messages in a higher layer. For example, when the satellite 220 functions as a base station, the satellite 220 may generate an MIB message, an SIB1 message, and an SIB19 message in a higher layer. When the satellite 220 functions as a relay device, the satellite 220 may receive an MIB message, an SIB1 message, and an SIB19 message generated by a base station in a higher layer and then may transmit the MIB message, the SIB1 message, and the SIB19 message back to the ground. The satellite 220 may repeatedly transmit the same block by using a physical layer for a plurality of broadcast messages. When the satellite 220 operates with repetition, the satellite 220 may repeatedly transmit each of broadcast messages generated in a higher layer while maintaining the same content.

A method of transmitting each of broadcast messages having the same content and repetition may be useful when information in a broadcast message does not frequently change and the size of the information is minimal (e.g. 64 bytes). A plurality of broadcast messages received by the terminal 210 may additionally include information such as a time interval between the broadcast messages and a location of the satellite 220, compared to existing broadcast messages. Accordingly, the size of the plurality of broadcast messages received by the terminal 210 may increase, compared to existing broadcast messages. In particular, considering periodicity and repetition, when one broadcast message (e.g., the SIB19 message) is generated, information related to all of the MIB message and the SIB1 message existing between the one SIB19 message and the SIB19 message to be generated after a designated time according to periodicity is required, thereby greatly increasing the overall size of a plurality of broadcast messages. When the overall size of a plurality of broadcast messages received by the terminal 210 increases, the broadcast message processing performance of the terminal 210 may decrease. A method of reducing a degree to which the overall size of a plurality of broadcast messages increases is disclosed herein, even when the terminal 210 receives the plurality of broadcast messages additionally including information such as a time interval between the broadcast messages and a location of the satellite 220.

The satellite 220 may generate a plurality of redundancy versions (rv's) for a broadcast message in a higher layer. The satellite 220 may generate a plurality of rv's to generate a broadcast message based on repetition. For example, when the satellite 220 generates the SIB19 message in a higher layer, the satellite 220 may generate rv's of the SIB19 message as many as the number of repetitions in one cycle based on periodicity and repletion and may transmit the rv's to a lower layer.

The satellite 220 transmits a broadcast message by using a lower layer while changing types of a plurality of rv's. Each of the plurality of rv's may include all broadcast messages required when calculating a TA value by using information including in the rv.

The terminal 210 may receive a plurality of rv's for at least one of a first broadcast message, a second broadcast message, or a third broadcast message generated in a higher layer of the satellite 220 and transmitted in a lower layer, may obtain location information of the satellite 220, and may calculate a TA value. For example, in the case of the SIB19 message related to a first rv (rv1) 1501, the MIB message, the SIB1 message, and the SIB19 message marked by thin solid lines may be required, and the terminal 210 may calculate a TA value by using information included in the MIB message, the SIB1 message, and the SIB19 message marked by the thin solid lines. For example, in the case of the SIB19 message related to a second rv (rv2) 1502, the MIB message, the SIB1 message, and the SIB19 message marked by dashed lines may be required, and the terminal 210 may calculate a TA value by using information included in the MIB message, the SIB1 message, and the SIB19 message marked by the dashed lines. For example, in the case of the SIB19 message related to a third rv (rv3) 1503, the MIB message, the SIB1 message, and the SIB19 message marked by thick solid lines may be required, and the terminal 210 may calculate a TA value by using information included in the MIB message, the SIB1 message, and the SIB19 message marked by the thick solid lines. When the satellite 220 transmits a broadcast message by using a lower layer while changing types of a plurality of rv's, the overall size of a plurality of broadcast messages received by the terminal 210 may be reduced compared to when the satellite 220 repeats the same broadcast message without an rv. The overall size of the plurality of broadcast messages received by the terminal 210 may be reduced to a value obtained by dividing the overall size by types of the plurality of rvs. For example, when the satellite 220 generates rv1 1501, rv2 1502, and rv3 1503, the overall size of a plurality of broadcast messages received by the terminal 210 may be reduced to ⅓, compared to when the satellite 220 repeats the same broadcast message without an rv.

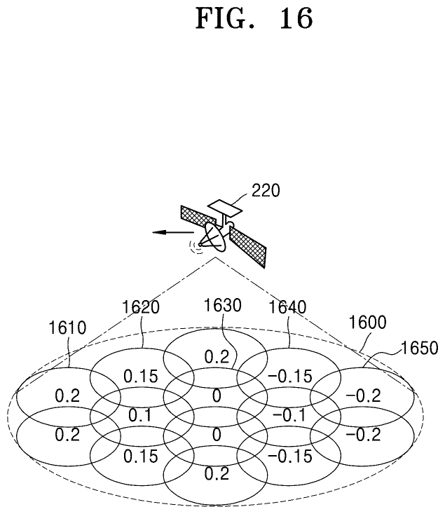

FIG. 16 illustrates a representative TA difference value received by the terminal 210 in an earth-moving cell, according to an embodiment. In an NTN, there are three operating methods for a cell of the satellite 220: an earth-moving cell, a quasi earth-fixed cell, and an earth-fixed cell. In an NTN using a low earth orbit satellite, two operating methods, that is, an earth-moving cell and a quasi earth-fixed cell, may be applied. Whether a representative TA (rTA) difference value in a cell changes may be determined according to an operating method.

Herein, a broadcast message may include an rTA difference diff for the terminal 210 that is RRC-connected. The terminal 210 may receive the broadcast message including the rTA difference value. The terminal 210 may more accurately calculate a TA value by reflecting the rTA difference value.

The satellite 220 may calculate an rTA difference value for each cell based on location information of the satellite 220 over NTN cells. The satellite 220 may include the calculated rTA difference value in a broadcast message (e.g., an SIB19 message). The satellite 220 may transmit the broadcast message including the rTA difference value.

The terminal 210 may receive the broadcast message including the rTA difference value. The terminal 210 may apply the rTA difference value to each of subframes. The terminal 210 may correct a TA value based on the rTA difference value.

In an earth-moving cell, an rTA difference value may maintain a constant value regardless of the mobility of the satellite 220. In an earth-fixed cell, each of a plurality of cells belonging to a region 1600 below the satellite 220 may have one fixed rTA difference value. For example, a first cell 1610 included in the region 1600 may have an rTA difference value of 0.2. For example, a second cell 1620 included in the region 1600 may have an rTA difference value of 0.15. For example, a third cell 1630 included in the region 1600 may have an rTA difference value of 0. For example, a fourth cell 1640 included in the region 1600 may have an rTA difference value of −0.15. For example, a fifth cell 1650 included in the region 1600 may have an rTA difference value of −0.2.

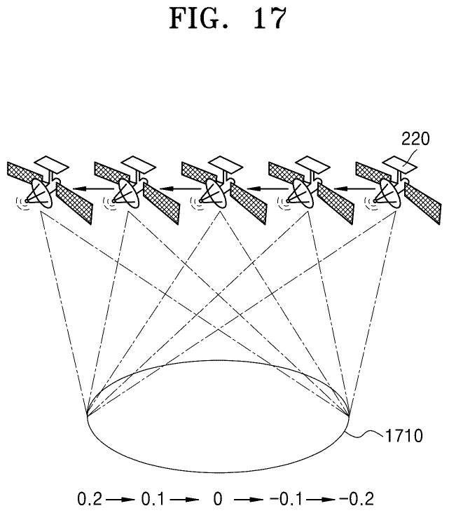

FIG. 17 illustrates an rTA difference value received by the terminal 210 in a quasi earth-fixed cell, according to an embodiment.

Referring to FIG. 17, in a quasi earth-fixed cell 1710, a representative TA difference value may change as time passes. For example, in the quasi earth-fixed cell 1710, an rTA difference value may change from 0.2 to 0.1, 0. −0.1, and −0.2, by reflecting that the satellite 220 moves over the quasi earth-fixed cell 1710 as time elapses. Because the satellite 220 generates a broadcast message (e.g., an SIB19 message) including an rTA difference value, the satellite 220 may generate a broadcast message by including an rTA difference value that changes whenever a broadcast message including a TA difference value is generated.

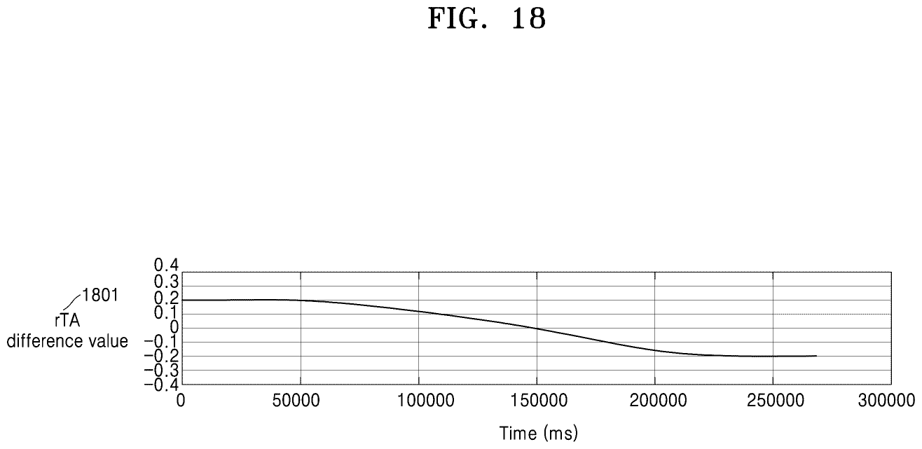

FIG. 18 illustrates an rTA difference value of the terminal 210 in the quasi earth-fixed cell 1710, according to an embodiment.

Referring to FIG. 18, in the quasi earth-fixed cell 1710, an rTA difference value may change by reflecting a relative location of the satellite 220 that changes as time passes. For example, in the quasi earth-fixed cell 1710, an rTA difference value 1801 may gradually change from 0.2 to −0.2 by reflecting a relative location of the satellite 220 that changes as time 1802 elapses.

The satellite 220 may generate a broadcast message (e.g., an SIB19 message) including an rTA difference value 1801. In this case, the satellite 220 may include a change value rTA_diff_variation of the rTA difference value 1801 in the generated broadcast message. The satellite 220 may transmit the broadcast message including the rTA difference value 1801.

The terminal 210 may receive the broadcast message including the rTA difference value 1801. The terminal 210 may correct a TA value by using the rTA difference value 1801.

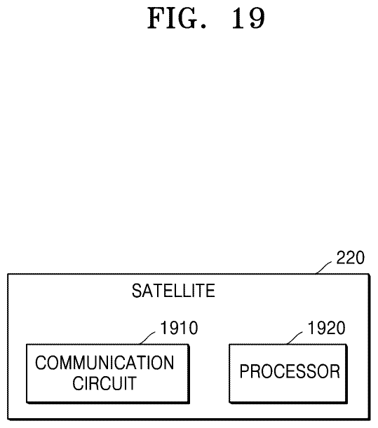

FIG. 19 illustrates the satellite 220, according to an embodiment.

Referring to FIG. 19, the satellite 220 may include a communication circuit 1910 and at least one processor 1920. The communication circuit 1910 may include an antenna, an amplifier, and a transfer circuit. However, this is only an example, and elements of the communication circuit 1910 are not limited thereto and the communication circuit 1910 may include more or fewer elements than those described above. The antenna may receive an external signal or may transmit a channel signal generated by the at least one processor 1920 to the outside. The amplifier may amplify the external signal received by the antenna or the channel signal generated by the at least one processor 1920. The transfer circuit may transmit the external signal received by the antenna to the at least one processor 1920 or may transmit the channel signal generated by the at least one processor 1920 to the antenna. The communication circuit 1910 may be described as a transceiver in the disclosure.

The at least one processor 1920 may be electrically connected to the communication circuit 1910. The at least one processor 1920 may receive a signal received and amplified by the communication circuit 1910. The at least one processor 1920 may process the signal received from the communication circuit 1910. The at least one processor 1920 may generate a channel signal based on a result of processing the signal received from the communication circuit 1910. The at least one processor 1920 may transmit the channel signal to the communication circuit 1910.

The communication circuit 1910 may transmit a first broadcast message, a second broadcast message, and a third broadcast message. The at least one processor 1920 may control the communication circuit 1910 to transmit the first broadcast message, the second broadcast message, and the third broadcast message. For example, the at least one processor 1920 may transmit the first broadcast message including at least part of synchronization information through the communication circuit 1910 at a first time point. The at least one processor 1920 may transmit the second broadcast message including the remainder of the synchronization information through the communication circuit 1910 at a second time point. The at least one processor 1920 may transmit the third broadcast message including location information related to a location of the satellite 220 through the communication circuit 1910 at a third time point.

The at least one processor 1920 may receive an initial message for initial access from the terminal at a time point adjusted according to a TA value determined based on a first location of the satellite 220 at the first time point, a second location of the satellite 220 at the second time point, and a third location of the satellite 220 at the third time point through the communication circuit 1910. A method by which a terminal determines a TA value may correspond to any of the methods described herein.

A communication method of a terminal, the terminal, a communication method of a satellite, and the satellite in an NTN system may enable synchronization and initial access between a terminal and a satellite without the help of a global navigation system.

A method may be implemented as a program command executable through various computer means and may be recorded on a computer-readable medium. The computer-readable medium may include program commands, data files, and data structures separately or in combinations. The program commands recorded on the medium may be specially designed and configured for the disclosure or may be well-known to and be usable by one of ordinary skill in the art of computer software. Examples of the computer-readable recording medium include a magnetic medium such as a hard disk, a floppy disk, or a magnetic tape, an optical medium such as a compact disc read-only memory (CD-ROM) or a digital versatile disc (DVD), a magneto-optical medium such as a floptical disk, and a hardware device specially configured to store and execute program commands such as a ROM, a random-access memory (RAM), or a flash memory. Examples of the program commands include advanced language code that may be executed by a computer by using an interpreter or the like as well as machine language code made by a compiler.

Some embodiments of the disclosure may also be realized in the form of a recording medium including instructions executable by a computer, such as a program module executed by a computer. The computer-readable medium may be an arbitrary available medium accessible by a computer, and includes all volatile and non-volatile media and separable and non-separable media. The computer-readable medium may include a computer storage medium and a communication medium. Examples of the computer storage medium include all volatile and non-volatile media and separable and non-separable media, which have been implemented by an arbitrary method or technology, for storing information such as computer-readable instructions, data structures, program modules, and other data. The communication medium generally includes a computer-readable instructions, a data structure, a program module, other data of a modulated data signal such as a carrier wave, or another transmission mechanism, and an example thereof includes an arbitrary information transmission medium. Some embodiments of the disclosure may also be implemented as a computer program or a computer program product including instructions executable by a computer, such as a computer program executed by a computer.

The machine-readable storage medium may be provided as a non-transitory storage medium, where non-transitory indicates that the storage medium does not include a signal (e.g., an electromagnetic wave) and is tangible, but does not distinguish whether data is stored semi-permanently or temporarily in the storage medium. For example, the non-transitory storage medium may include a buffer in which data is temporarily stored.

Methods herein may be provided in a computer program product. The computer program product is a product purchasable between a seller and a purchaser. The computer program product may be distributed in the form of a machine-readable storage medium (e.g., a CD-ROM), or distributed (e.g., downloaded or uploaded) online via an application store or between two user devices (e.g., smartphones) directly. When distributed online, at least part of the computer program product (e.g., a downloadable application) may be temporarily generated or at least temporarily stored in a machine-readable storage medium, such as a memory of a server of a manufacturer, a server of an application store, or a relay server.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method of a terminal in a non-terrestrial network, the method comprising:
receiving a first broadcast message including at least part of synchronization information from a satellite at a first time point;
receiving a second broadcast message including a remainder of the synchronization information from the satellite at a second time point;
receiving a third broadcast message including location information related to a location of the satellite from the satellite at a third time point;
determining a first location of the satellite at the first time point, a second location of the satellite at the second time point, and a third location of the satellite at the third time point, based on the first broadcast message, the second broadcast message, and the third broadcast message;
determining a timing advance (TA) value related to a distance between the terminal and the satellite, based on the first location, the second location, and the third location;
adjusting a transmission time point of an initial message for initial access to the satellite, based on the determined TA value; and
transmitting the initial message to the satellite at the adjusted transmission time point.

2. The method of claim 1,
wherein at least one of the first broadcast message or the second broadcasting method includes information about a transmission time interval in the satellite between the first broadcast message, the second broadcast message, and the third broadcast message received by the terminal.

3. The method of claim 1,
wherein at least one of the first broadcast message or the second broadcast message includes information about a reception time interval in the terminal between the first broadcast message, the second broadcast message, and the third broadcast message received by the terminal.

4. The method of claim 1,
wherein the third broadcast message includes, at a time point when each of the first broadcast message, the second broadcast message, and the third broadcast message received by the terminal is transmitted, location information of the satellite transmitting each broadcast message.

5. The method of claim 1,
wherein the terminal is configured to calculate a first distance between the terminal and the satellite at the first time point based on Stewart's Theorem.

6. The method of claim 5,
wherein the terminal is further configured to calculate an initial message transmission distance between the terminal and the satellite at an initial message transmission time point when the terminal transmits the initial message, based on the calculated first distance and the Stewart's Theorem.

7. The method of claim 1,
wherein the terminal is configured to set a time interval between the first broadcast message, the second broadcast message, and the third broadcast message transmitted by the satellite to a same value.

8. The method of claim 1,
wherein the terminal is configured to, when at least two of the first broadcast message, the second broadcast message, or the third broadcast message are received in a same slot, receive an additional broadcast message after receiving the first broadcast message, the second broadcast message, and the third broadcast message.

9. The method of claim 1,
wherein the terminal is configured to calculate the TA value by obtaining location information of the satellite by receiving a plurality of redundancy versions for at least one of the first broadcast message, the second broadcast message, or the third broadcast message generated in a higher layer of the satellite and transmitted in a lower layer of the satellite.

10. The method of claim 1,
wherein the terminal is configured to correct the TA value by using a representative TA difference value included in at least one of the first broadcast message, the second broadcast message, or the third broadcast message.

11. A terminal of a non-terrestrial network, the terminal comprising:
a transceiver; and
at least one processor connected to the transceiver and configured to:
receive a first broadcast message including at least part of synchronization information from a satellite at a first time point,
receive a second broadcast message including a remainder of the synchronization information from the satellite at a second time point,
receive a third broadcast message including location information related to a location of the satellite from the satellite at a third time point,
determine a first location of the satellite at the first time point, a second location of the satellite at the second time point, and a third location of the satellite at the third time point, based on the first broadcast message, the second broadcast message, and the third broadcast message,
determine a timing advance (TA) value related to a distance between the terminal and the satellite, based on the first location, the second location, and the third location,
adjust a transmission time point of an initial message for initial access to the satellite, based on the determined TA value, and
transmit the initial message to the satellite at the adjusted transmission time point.

12. The terminal of claim 11,
wherein at least one of the first broadcast message or the second broadcast message includes information about a transmission time interval in the satellite between the first broadcast message, the second broadcast message, and the third broadcast message received by the terminal.

13. The terminal of claim 11,
wherein at least one of the first broadcast message or the second broadcast message includes information about a reception time interval in the terminal between the first broadcast message, the second broadcast message, and the third broadcast message received by the terminal.

14. The terminal of claim 11,
wherein the third broadcast message includes, at a time point when each of the first broadcast message, the second broadcast message, and the third broadcast message received by the terminal is transmitted, location information of the satellite transmitting each broadcast message.

15. The terminal of claim 11,
wherein the at least one processor is further configured to calculate a first distance between the terminal and the satellite at the first time point based on Stewart's Theorem.

16. The terminal of claim 15,
wherein the at least one processor is further configured to calculate an initial message transmission distance between the terminal and the satellite at an initial message transmission time point when the terminal transmits the initial message, based on the calculated first distance and the Stewart's Theorem.

17. The terminal of claim 11,
wherein the at least one processor is further configured to set a time interval between the first broadcast message, the second broadcast message, and the third broadcast message transmitted by the satellite to a same value.

18. The terminal of claim 11,
wherein the at least one processor is further configured to, when at least two of the first broadcast message, the second broadcast message, or the third broadcast message are received in a same slot, receive an additional broadcast message after receiving the first broadcast message, the second broadcast message, and the third broadcast message.

19. The terminal of claim 11,
wherein the at least one processor is further configured to calculate the TA value by obtaining location information of the satellite by receiving a plurality of redundancy versions for at least one of the first broadcast message, the second broadcast message, or the third broadcast message generated in a higher layer of the satellite and transmitted in a lower layer of the satellite.

20. The terminal of claim 11,
wherein the at least one processor is further configured to correct the TA value by using a representative TA difference value included in at least one of the first broadcast message, the second broadcast message, or the third broadcast message.

21. A method of a satellite in a non-terrestrial network, the method comprising:
transmitting a first broadcast message including at least part of synchronization information from the satellite at a first time point;
transmitting a second broadcast message including a remainder of the synchronization information from the satellite at a second time point;
transmitting a third broadcast message including location information related to a location of the satellite from the satellite at a third time point; and
receiving an initial message for initial access from a terminal at a time adjusted according to a timing advance value determined based on a first location of the satellite at the first time point, a second location of the satellite at the second time point, and a third location of the satellite at the third time point,
wherein the first location of the satellite at the first time point, the second location of the satellite at the second time point, and the third location of the satellite at the third time point are determined based on the first broadcast message, the second broadcast message, and the third broadcast message.

22. A satellite of a non-terrestrial network, the satellite comprising:
a transceiver; and
at least one processor connected to the transceiver and configured to:
transmit a first broadcast message including at least part of synchronization information from the satellite at a first time point,
transmit a second broadcast message including a remainder of the synchronization information from the satellite at a second time point,
transmit a third broadcast message including location information related to a location of the satellite from the satellite at a third time point, and
receive an initial message for initial access from a terminal at a time adjusted according to a timing advance value determined based on a first location of the satellite at the first time point, a second location of the satellite at the second time point, and a third location of the satellite at the third time point,
wherein the first location of the satellite at the first time point, the second location of the satellite at the second time point, and the third location of the satellite at the third time point are determined based on the first broadcast message, the second broadcast message, and the third broadcast message.
